(19) United States
(12) Patent Application Publication
(10) Pub. No.: US 2025/0153510 A1
(43) Pub. Date: May 15, 2025

(54) NON-PNEUMATIC TIRE

(71) Applicant: The Goodyear Tire & Rubber Company, Akron, OH (US)

(72) Inventors: Daniel Ray Downing, Uniontown, OH (US); Junling Zhao, Hudson, OH (US)

(21) Appl. No.: 18/506,389

(22) Filed: Nov. 10, 2023

(51) Int. Cl. B60C 9/18; B60C 1/00; B60C 7/22

(52) U.S. Cl. CPC B60C 9/18; B60C 7/22; B60C 2001/005

(57) ABSTRACT

The present invention is directed to a non-pneumatic tire comprising a tread portion, bead portions, a belt portion, and at least one carcass ply including a top portion extending radially below and along the belt portion. Furthermore, the carcass ply has two laterally opposite side portions wherein each side portion extends from the top portion towards a respective bead portion. Still in accordance with the invention, the tire comprises a shearband extending in a circumferential direction radially below and along the top portion of the at least one carcass ply to support both side portions of the at least one carcass ply in an axial direction. Moreover, the present invention is directed to a tire rim assembly comprising such a tire.

### FIELD OF THE INVENTION

The present invention is directed to a tire comprising a shearband below a carcass ply of the tire. The present invention is also directed to a tire rim assembly comprising such a tire, and a method of making such a tire.

### BACKGROUND OF THE INVENTION

An advantage of non-pneumatic tires consists in that they do not require pressured air within a tire cavity and are thus puncture resistant. However, a typical disadvantage of non-pneumatic tires consists in that they require different manufacturing methods and/or tire components than conventional pneumatic tires. While progress has been made in the development of non-pneumatic tires over the past years, significant room for improvement remains.

### SUMMARY OF THE INVENTION

In a first aspect, the present invention is directed to a tire comprising a tread portion, a pair of bead portions wherein each bead portion comprises a bead and a bead apex, and a pair of sidewalls wherein each sidewall extends from the tread portion to a respective one of the bead portions. Furthermore, the tire comprises a belt portion comprising at least one belt layer at least partially supporting the tread portion, and at least one carcass ply including a top portion extending radially below and along the belt layer. Moreover, the carcass ply includes two laterally opposite side portions wherein each side portion extends from the top portion towards a respective one of the bead portions. Still in accordance with the first aspect, the tire comprises a shearband extending in a circumferential direction radially below and along the top portion of the at least one carcass ply to support both side portions of the at least one carcass ply in an axial direction.

In a second aspect, the present invention is directed to a tire comprising a tread portion, a pair of bead portions wherein each bead portion comprises a bead, and a pair of sidewalls wherein each sidewall extends from the tread portion to a respective one of the bead portions. Furthermore, the tire comprises a belt portion comprising at least one belt layer at least partially supporting the tread portion, and at least one carcass ply including a top portion extending radially below and along the belt layer. Moreover, the carcass ply includes two laterally opposite side portions wherein each side portion extends from the top portion towards a respective one of the bead portions. Still in accordance with the first aspect, the tire comprises a shearband extending in a circumferential direction radially below and along the top portion of the at least one carcass ply to support both side portions of the at least one carcass ply in an axial direction.

In a third aspect, the invention is directed to a tire rim assembly comprising a rim and a tire in accordance with the first or second aspect, and optionally one or more of its embodiments.

In a fourth aspect, the invention is directed to a method of manufacturing a non-pneumatic tire comprising a step of providing a tire comprising: i) a tread portion, ii) a pair of bead portions wherein each bead portion comprises a bead and optionally a bead apex, iii) a pair of sidewalls, iv) a belt portion comprising at least one belt layer, and v) at least one carcass ply including a top portion extending radially below and along the belt layer, and two laterally opposite side portions wherein each side portion extends from the top portion towards a respective one of the bead portions. Furthermore, the method comprises a step of circumferentially applying a shearband radially below and along the top portion of the at least one carcass ply to contact and support both side portions of the at least one carcass ply in an axial direction.

### BRIEF DESCRIPTION OF THE DRAWINGS

The invention will be described by way of example and with reference to the accompanying drawings in which:

FIG. 1 is a schematic cross-section of a tire comprising a polyurethane shearband radially below a top portion of carcass plies, in accordance with an embodiment of the present invention;

FIG. 2 is a schematic cross-section of another tire comprising a cord reinforced shearband comprising multiple layers radially below a top portion of carcass plies, in accordance with another embodiment of the present invention; and

FIG. 3 is a schematic cross-section of a tire rim assembly comprising a rim tensioning bead portions of the tire in axially inner directions, and a tire comprising a shearband tensioning side portions of a carcass in axially outer directions.

### DETAILED DESCRIPTION OF THE INVENTION

According to the first aspect, a tire, particularly a non-pneumatic tire, comprises a tread portion, a pair of bead portions wherein each bead portion comprises a bead and a bead apex, and a pair of sidewalls wherein each sidewall extends from the tread portion to a respective one of the bead portions. Furthermore, the tire comprises a belt portion comprising at least one belt layer at least partially supporting the tread portion, and at least one carcass ply including a top portion extending radially below and along the belt layer. Moreover, the carcass ply includes two laterally opposite side portions wherein each side portion extends from the top portion towards a respective one of the bead portions. The tire further comprises a shearband extending in a circumferential direction radially below and along the top portion of the at least one carcass ply to support and/or tension both side portions of the at least one carcass ply in an axial direction. In particular, the side portions are preferably supported and/or tensioned in radially outer regions of the side portions.

In one embodiment, the shearband is (directly) attached to the carcass ply, and/or extends in the circumferential direction along the top portion on a radially inner surface of the carcass ply, and/or supports both side portions in an axial direction in contact with the carcass ply at a radially outer region (or portion) of each side portion. Thus, an innerliner is not necessary and present in accordance with this embodiment.

In still another embodiment, the tire is devoid of a butyl rubber comprising innerliner.

In another embodiment, the bead comprises one or more of multiple wires, a brass coating, and a rubber coating composition. Thus, the bead preferably comprises multiple components and is not just a single steel wire. At each bead, the at least one carcass ply may be folded around the bead and/or turned up around the bead.

In another embodiment, the tire comprises an innerliner, preferably on an inner surface of the at least one carcass ply, wherein the shearband is attached to the innerliner. In particular, such an innerliner renders the tire airtight. Such an innerliner could, e.g., be used to obtain a tire which partially relies on air pressure. For instance, the innerliner may comprise a rubber composition comprising butyl rubber. Such a composition is preferred to provide an airtight innerliner. Optionally, the shearband extends in the circumferential direction along the top portion on a radially inner surface of the innerliner or carcass ply and supports both side portions of the at least one carcass ply in an axial direction and/or in contact with the innerliner, preferably at a radially outer portion of each side portion.

In still another embodiment, the shearband has a maximum radial thickness within a range of 50% to 300%, preferably 70% to 300%, or more preferably 70% to 200% of the maximum radial thickness of the tread, determined radially above the at least one belt layer, preferably an axially narrowest of the at least one belt layer.

In still another embodiment, the tire is a cured tire, optionally comprising a post-cure added shearband. Thus, it is possible to provide a cured pneumatic tire with features in accordance with the present invention and add the shearband to the inner surface (facing the tire cavity) of the cured tire.

In still another embodiment, the shearband comprises one or more of:
i) multiple cord reinforced elastomer composition (e.g., rubber composition) layers arranged radially on top of one another;
ii) polyurethane and/or epoxy resin, having one or more of:
   a density within a range of 0.5 g/cm³ to 2 g/cm³, preferably from 0.9 g/cm³ to 1.3 g/cm³, determined according to ASTM D792, or equivalent,
a stiffness/flexural modulus within a range of 0.5 GPa to 3 GPa, preferably 0.5 GPa to 1.5 GPa, determined according to ASTM D790, or equivalent, and
   a hardness within a range of 65 durometer A to 70 durometer D, determined according to ASTM D2240, or equivalent; and
iii) a thermoplastic polymer having one or more of:
   a density within a range of 0.5 g/cm³ to 3 g/cm³, preferably 0.9 g/cm³ to 2.2 g/cm³, determined according to ASTM D792 and/or ISO 1183, or equivalent,
   a stiffness/flexural modulus within a range of 0.5 GPa to 10 GPa, preferably 0.5 GPa to 1.5 GPa, according to ASTM D790, or equivalent, and
   a hardness within a range of 65 durometer A to 70 durometer D, determined according to ASTM D2240, or equivalent.

Flexural modulus is determined herein at 23° C. Other properties are determined at the same temperature, unless indicated otherwise herein.

In still another embodiment, the shearband and/or the tire is devoid of foam material, in particular devoid of polyurethane foam.

In another embodiment, the thermoplastic polymers are thermoplastic elastomers.

In still another embodiment, the thermoplastic polymers and/or thermoplastic elastomers are selected from one or more of styrenic thermoplastic elastomers, thermoplastic polyolefin elastomers, elastomer alloy thermoplastic vulcanizates, copolyester thermoplastic elastomers, thermoplastic polyurethane elastomers, and polyamide thermoplastic elastomers.

In still another embodiment, said polyurethane and/or epoxy resin comprises fibers and/or filaments. Optionally, such fibers and/or filaments are selected from one or more of textile, glass, carbon, and natural fibers and/or filaments.

In still another embodiment, the shearband can be mentioned as a band comprising layers and/or materials as mentioned herein, and/or having one or more of the properties mentioned herein, such as density, stiffness, and hardness.

In still another embodiment, the shearband or band tensions and/or supports the at least one carcass ply against shear forces and/or forces acting in the axial direction.

In still another embodiment, the pair of sidewalls can be a pair of sidewall components, such as used in tire building of pneumatic tires.

In still another embodiment, the tire further comprises at least one additional insert and/or layer supporting (and/or stiffening) one or more of a shoulder portion of the tire, the bead portion, and at least one sidewall. Preferably, such an insert and/or layer comprises an elastomer composition which has a higher stiffness than a stiffness of an elastomer composition of the sidewall. Preferably, such a stiffness is at least 10% higher than the stiffness of the elastomer composition of the sidewalls. The stiffness of an elastomer or rubber composition is determined herein as G′ with an RPA 2000™ Rubber Process Analyzer of the company Alpha Technologies, at a temperature of 100° C., 1% strain, and a frequency of 1 Hz, based on ASTM D5289, or equivalent.

In still another embodiment, the tire further comprises a pair of chafers, wherein each chafer preferably contacts a radially lower/inner end of a respective sidewall in a respective bead portion of the tire.

In another embodiment, cord reinforcements (e.g., of the shearband, or one or more of its layers) comprise textile and/or metal cords. Preferably, at least two elastomer or rubber composition layers are reinforced by metal cords. In addition, or alternatively, at least two elastomer or rubber composition layers are reinforced by textile cords. Thus, it is possible that a shearband comprises multiple cord reinforced elastomer, optionally rubber, layers comprising multiple layers which are textile cord reinforced and multiple layers which are metal cord reinforced.

In another embodiment, the cord reinforced layers of the shearband comprise only textile reinforcements.

Preferably, all layers of the shearband are textile cord reinforced and/or devoid of metal cords.

Preferably, metal cords mentioned herein are made of steel and/or are brass coated.

In still another embodiment, the shearband comprises at least four (preferably at least 5 or 6) cord reinforced elastomer composition (e.g., rubber composition) layers arranged radially on top of each other. The shearband preferably comprises less than 20 of such layers.

In still another embodiment, each layer has a radial thickness within a range of 0.2 mm to 3 mm, preferably 0.3 mm to 2.5 mm.

In still another embodiment, the shearband comprises at least one, preferably helically applied, rubber composition ply strip comprising multiple parallel (reinforcement) cords, wherein the cords have an angle with the circumferential direction (of the tire) of less than 5°, preferably of less than 2°, or even less than 1°.

In still another embodiment, each ply strip has an (axial) width within a range of 3 mm to 25 mm, preferably of 4 mm to 16 mm. In addition, or alternatively, each ply strip has a (radial) thickness within a range of 0.5 mm to 2.5 mm, preferably of 0.9 mm to 2 mm.

In still another embodiment, the ply strip comprises from 2 to 12 parallel cords, preferably from 2 to 5 parallel cords.

In still another embodiment, the shearband comprises one or more of the following materials:
i) polyurethane and/or epoxy resin, having one or more of:
   a density within a range of 0.5 g/cm³ to 2 g/cm³, preferably from 0.9 g/cm³ to 1.3 g/cm³, determined according to ASTM D792, or equivalent,
   a flexural modulus within a range of 0.5 GPa to 3 GPa, preferably 0.5 GPa to 1.5 GPa, determined according to ASTM D790, or equivalent, and
   a hardness within a range of 65 durometer A to 70 durometer D, determined according to ASTM D2240, or equivalent; and
ii) a thermoplastic polymer having one or more of:
   a density within a range of 0.5 g/cm³ to 3 g/cm³, preferably 0.9 g/cm³ to 2.2 g/cm³, determined according to ASTM D792 and/or ISO 1183, or equivalent,
   a flexural modulus within a range of 0.5 GPa to 10 GPa, preferably 0.5 GPa to 1.5 GPa, according to ASTM D790, or equivalent, and
   a hardness within a range of 65 durometer A to 70 durometer D, determined according to ASTM D2240, or equivalent.

In still another embodiment, said material is 3D-printed. Optionally, it can be printed to form a lattice structure.

In yet another embodiment, the material is reinforced by one or more of cords, fabrics, and fibers, preferably by textile cords and/or textile fabrics.

In still another embodiment, textile cords comprise one or more of polyamide (such as Nylon), polyester, polyethylene terephthalate, aramid, glass fibers, carbon fibers, and natural fibers.

In still another embodiment, the side portions of the carcass ply are resiliently tensioned by the shearband, preferably essentially in the axial direction, such as the axially outer and/or axially inner direction.

In still another embodiment, the carcass ply is reinforced by textile cords, which preferably extend essentially perpendicularly to the circumferential direction of the tire.

According to the second aspect, a tire, particularly a non-pneumatic tire, comprises a tread portion, a pair of bead portions wherein each bead portion comprises a bead and optionally a bead apex, and a pair of sidewalls wherein each sidewall extends from the tread portion to a respective one of the bead portions. Furthermore, the tire comprises a belt portion comprising at least one belt layer at least partially supporting the tread portion, and at least one carcass ply including a top portion extending radially below and along the belt layer. Moreover, the carcass ply includes two laterally opposite side portions wherein each side portion extends from the top portion towards a respective one of the bead portions. The tire further comprises a shearband extending in a circumferential direction radially below and along the top portion of the at least one carcass ply to support and/or tension both side portions of the at least one carcass ply in an axial direction. In particular, the side portions are preferably supported and/or tensioned in radially outer regions of the side portions. Thus, bead apexes are optional in this aspect.

According to the third aspect, a tire rim assembly is provided which comprises a rim and a tire in accordance with the first or second aspect, or one of its embodiments.

In one embodiment, the rim has a first circumferential flange portion radially supporting and forcing (and/or tensioning) a first bead portion of the pair of bead portions in one of an axially inner direction and an axially outer direction. Furthermore, the rim comprises a second circumferential flange portion radially supporting and forcing (and/or tensioning) a second bead portion of the pair of bead portions in the same of the axially inner direction and axially outer direction as the first bead portion, when the tire is mounted to the rim. In other words, both bead portions are either forced in axially inner directions/axially towards each other, or in axially outer directions/axially away from each other.

In another embodiment, at least one bead portion is (at least partially) axially clamped at (or in) at least one of the first circumferential flange portion and the second circumferential flange portion. Such clamping can help to avoid undesirable tire rim slip.

In another embodiment, the flange portions tension both lateral side portions of the at least one carcass ply by forcing both bead portions into axially inner directions (or in other words, towards each other), preferably against a tension of the shearband forcing and/or tensioning the side portions into axially outer directions, such as in a radially outer region or portion of each side portion.

In still another embodiment, the flange portions tension both lateral side portions of the at least one carcass ply by forcing both bead portions into axially outer directions (or in other words, away from each other), preferably against a tension of the shearband tensioning the side portions into axially inner directions, such as in a radially outer portion of each side portion. In particular, as the shearband is connected to the side portions, it at least partially holds the side portions against the tension of the flange portions.

In still another embodiment, an axial distance between axially innermost surfaces of the first bead portion and the second bead portion is at least 10%, at least 20%, at least 30%, preferably at least 35%, or even 40%, smaller than a maximum axial width of the shearband, when the tire is mounted to the rim.

In still another embodiment, said axial distance is from 10% to 70%, preferably from 20% to 70%, or even more preferably from 35% to 70%, smaller than the maximum axial width of the shearband, when the tire is mounted to the rim.

In yet another embodiment, the rim comprises multiple separate members (mountable to one another) comprising a circumferential hub member and a circumferential ring member, wherein the circumferential hub member comprises the first circumferential flange portion and wherein the circumferential ring member comprises the second circumferential flange portion, and wherein the circumferential ring member is preferably axially mountable to the circumferential hub member.

In another embodiment, the circumferential ring member has essentially the same radial diameter as the circumferential hub member and/or a diameter within a range of 90% to 110% of the diameter of the circumferential hub member.

In another embodiment, the circumferential ring member and the circumferential hub member can be axially attached to each other by fastening means, such as including one or more of bolts, screws and nuts.

In still another embodiment, the circumferential hub member comprises a further circumferential flange portion supporting the first bead portion against movement in an axial direction, particularly against movement in an axial direction opposite to the axial direction in which the first bead portion is forced by the first flange portion.

In still another embodiment, when the circumferential ring member is mounted to the circumferential hub member, the first bead portion is axially clamped between the first circumferential flange portion and the further circumferential flange portion.

In still another embodiment, the tire and the rim enclose a circumferential tire cavity having a relative air pressure compared to the air pressure of the environment which is less than 0.3 bar or uninflated. Alternatively, or in addition, the tire rim assembly is devoid of an air pressure valve for inflating the tire.

In still another embodiment, the shearband does not extend radially down to the bead portions, and/or fills less than a third of a tire cavity volume enclosed by the innerliner and/or at least one carcass ply and one or more chafers.

In the fourth aspect, the invention is directed to a method of manufacturing a tire, in particular a non-pneumatic tire, comprising a first step of providing a tire, the tire comprising i) a tread portion, ii) a pair of bead portions wherein each bead portion comprises a bead and optionally a bead apex, iii) a pair of sidewalls, iv) a belt portion comprising at least one belt layer, and v) at least one carcass ply including a top portion extending radially below and along the belt layer, and two laterally opposite side portions wherein each side portion extends from the top portion towards a respective one of the bead portions. Furthermore, the method comprises a step of circumferentially applying a shearband radially below and along the top portion of the at least one carcass ply to contact and support both side portions of the at least one carcass ply in an axial direction.

In one embodiment of the method, the tire provided in the first step may further comprise an innerliner, preferably enclosing a tire cavity.

In another embodiment, the tire is devoid of such an innerliner. Optionally, said at least one carcass ply may enclose the tire cavity, optionally together with one or more chafers.

In another embodiment, the tire provided in the first step may be a pneumatic tire and/or a cured tire. In other words, it is possible to use a cured pneumatic tire and apply said shearband to an inner surface (such as of the innerliner or carcass ply) to obtain the non-pneumatic tire.

In another embodiment, said shearband is applied by helically applying at least one (preferably only one) cord-reinforced rubber composition ply strip in multiple layers radially below the top portion of the tire on an inner surface of the provided tire, such as on the innerliner.

In still another embodiment multiple angled plies are applied below the top portion of the tire on an inner surface of the provided tire to form the shearband.

In another embodiment, said shearband is applied to the tire in one piece (while it may optionally have multiple layers).

In still another embodiment, the shearband is cured to the provided tire (optionally pre-cured as such earlier).

In still another embodiment, curing the shearband to the tire may include a curing bladder or tube forcing the shearband in an axially outer direction onto an inner surface of the provided tire, such as onto the innerliner or at least one carcass ply. For instance, such a curing may take place in one of an oven, an autoclave, and a tire curing press.

In still another embodiment the shearband is attached to the tire by an adhesive, such as an RFL adhesive, rubber based adhesive, silicone based adhesive, polyurethane based adhesive or isocyanate based adhesive, and optionally cured afterwards to the tire.

In still another embodiment, polyurethane and/or epoxy resin is applied to an inner surface of the provided tire, radially below and along the top portion of the at least one carcass ply.

In still another embodiment, molten thermoplastic polymer is applied to an inner surface of the provided tire, radially below and along the top portion of the at least one carcass ply. Optionally, the thermoplastic polymer solidifies and/or hardens upon cooling, e.g., at 23° C.

In still another embodiment, the tire is rotated during application of one of said strip, polyurethane and/or epoxy resin, and thermoplastic polymer so as to form the shearband. For instance, it is possible to apply the polyurethane and/or epoxy resin, or thermoplastic polymer in layers.

In still another embodiment, the shearband is formed, e.g., by one of the above-mentioned materials, by additive manufacturing such as 3D printing or lamination of layers.

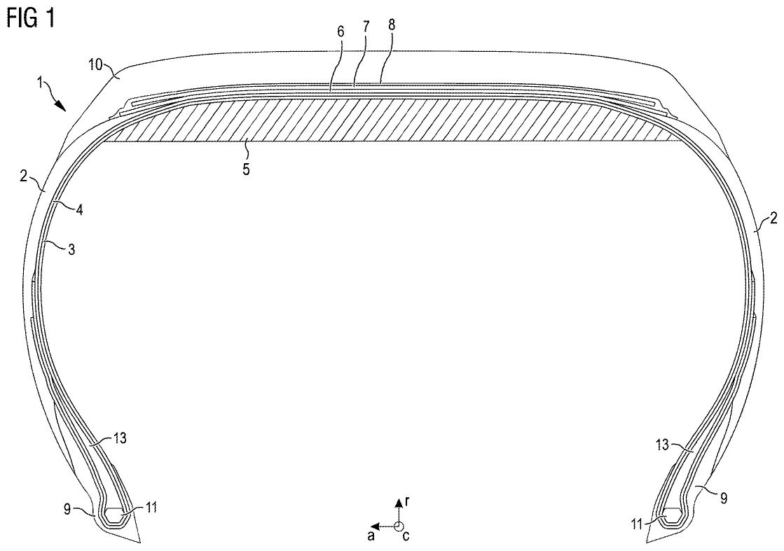

FIG. 1 shows an embodiment of a tire 1 comprising a tread portion 10, a pair of sidewalls 2, two carcass plies 3, 4, a pair of chafers 9, beads 11, bead apexes 13, a belt portion comprising two belt layers 6, 7, and an overlay 8. Furthermore, the tire 1 comprises a shearband 5, which is attached to a radial top portion of the (radially) inner carcass ply 3, and which extends from one lateral side of the tire 1 to an opposite lateral side of the tire 1 over a width larger than the axially broadest belt layer 6. In the present example, the shearband 5 is made of polyurethane molded to the carcass ply 3. In this example, liquid urethane has been applied to the inner surface of a rotating tire. Alternatively, polyurethane could be extruded and then applied as a band to the tire. For instance, a bladder, such as a curing bladder, could be used to press and/or adhere the polyurethane to the inner surface of the tire. In other words, it can also be co-cured to the tire, such as utilizing sulfur or peroxide cure. In another example, polyurethane could be attached to the carcass ply with the help of an adhesive, such as an isocyanate adhesive. In addition, or alternatively, adhesion could be provided by using functional polymers in the carcass ply and/or inner liner, such as comprising one or more functional groups, such as hydroxide groups.

The axial direction a (which is parallel to the axis of rotation of the tire), the radial direction r, (which is perpendicular to the axial direction a), and the circumferential direction c (which is parallel to the circumference of the tire and perpendicular to the radial and axial directions) are indicated in FIG. 1 for the sake of better comprehensibility. A reference to one of these directions does not necessarily limit such a direction to a specific orientation unless indicated otherwise herein.

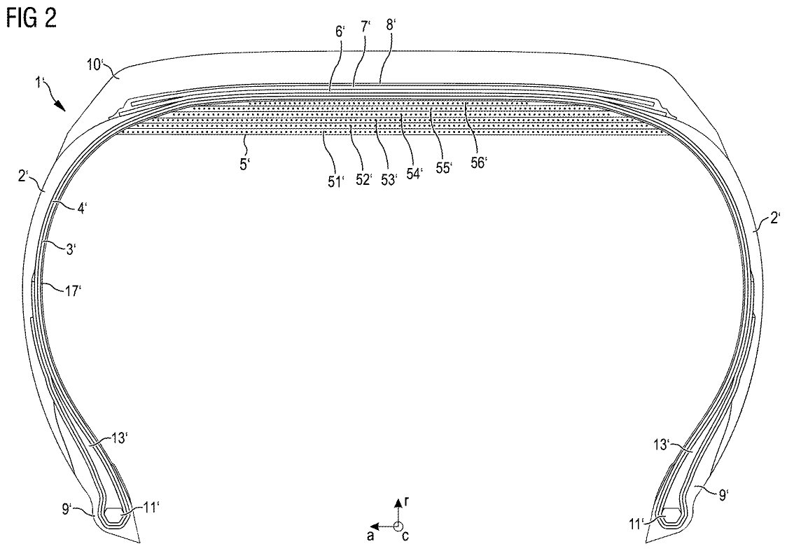

FIG. 2 shows another preferred embodiment of the present invention. Similar to the tire 1 shown in FIG. 1, the tire 1′ shown in FIG. 2 comprises a tread portion 10′, a pair of sidewalls 2′, two carcass plies 3′, 4′, a pair of chafers 9′, beads 11′, bead apexes 13′, a belt portion comprising two belt layers 6′, 7′, and an overlay 8′. Furthermore, the tire 1′ comprises an innerliner 17′ and a shearband 5′ attached to a radial top portion of the carcass ply 6′ via the innerliner 17′ and extending from one lateral side of the tire 1′ to an opposite lateral side of the tire 1′. While the present embodiment has an innerliner 17′, it would also be possible to omit the innerliner 17′ and attach the shearband 5′ directly onto the carcass ply 3′ (not shown).

In the present embodiment, the shearband 5′ comprises six parallel and/or stacked layers 51′, 52′, 53′, 54′, 55′, and 56′. Each layer extends essentially in an axial direction and/or essentially in parallel to the belt layers 6′, 7′. Each layer is reinforced in the present example by cords which have a low angle with the circumferential direction, which is smaller than 2°. It is possible that each layer is formed by a helically wound rubber ply strip comprising parallel cords. It is possible that each layer is formed by one ply strip, as shown here. However, optionally, all layers can be formed by the same reinforced ply strip, such as a textile cord reinforced rubber ply strip.

In the embodiments of FIGS. 1 and 2, the maximum radial thickness of the shearband is larger than the maximum radial thickness of the tread in an area radially above the narrowest belt layer.

A shearband is preferably co-cured to the tire using sulfur cure. Peroxide cure could also be used. The tire may be cured before the preferably uncured shearband is co-cured to the tire. In embodiments in which the shearband consists of one or more cured rubber compositions before attachment to a cured tire (less preferred), the shearband may be bonded to the tire via one or more adhesives, such as selected from rubber based, silicone based, isocyanate based, epoxide based, and polyurethane based adhesives. Optionally, a curing cement, such as used for retreading tires, is used to co-cure the shearband to the tire. The use of a green rubber layer is also possible for co-curing the shearband to the tire. Furthermore, it is possible that the tire is a green/uncured tire and the uncured shearband is cured to the uncured tire. Optionally, one or more functional polymers may be used in the shearband and/or the carcass ply or innerliner which allow bonding of the shearband to the carcass ply or innerliner. Such functional groups may comprise but are not limited to isocyanate, hydroxide, halogenide, amine, amide, carboxylic, epoxide, peroxide, and other suitable groups.

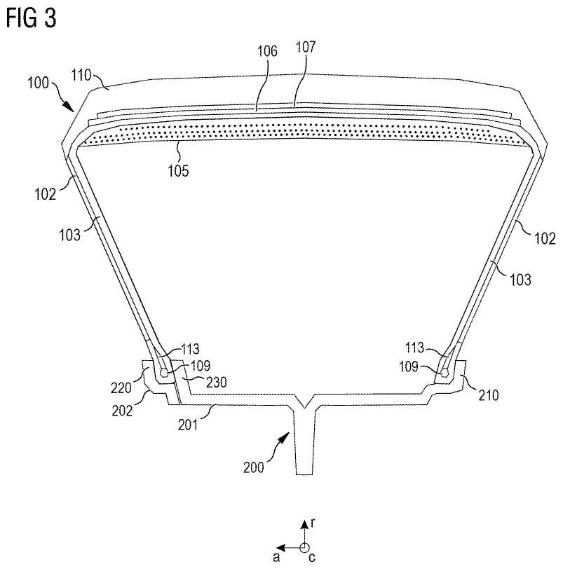

The embodiment of FIG. 3 shows a schematic partial cross-section of a tire rim assembly comprising a tire 100 and a portion of a rim 200, wherein the tire 100 is mounted onto the rim 200. The tire 100 comprises a tread portion 110, two belt layers 106, 107, a pair of sidewalls 102, a carcass ply 103, a cord reinforced shearband 105, beads 109, and bead apexes 113. In particular, the shearband 105 consists of multiple cord reinforced layers cured together and to the tire, such as in a tire curing press, e.g., with a curing bladder. Before curing the shearband 105 to the tire, the tire was already cured. The shearband 105 supports radially upper side portions or regions of the carcass ply 103 against forces acting in an axial direction, such as in an axially inner direction. Bead portions of the tire 100, comprising each a bead 109 and a bead apex 113 (which is preferred but optional), are supported by the rim 200. In particular, the rim 200 comprises a hub member 201 and a ring member 202 axially mountable, e.g., by bolts (not shown), to the hub member 201. The rim 200 comprises a first circumferential flange portion 210 and a second circumferential flange portion 220 which tension the side portions of the carcass ply 103 into a radially inner direction. In particular, the second flange portion 220 is provided on the circumferential ring member 202. A further flange portion 230 is provided on the hub member 201 to clamp one of the bead portions between the second flange portion 220 and the further flange portion 230. The flange portions 210, 220, 230 extend essentially in an radially outer direction. Moreover, the ring member 220 and the hub member 210 support each bead portion in a radially outer direction. As shown in FIG. 3, both bead portions are forced and/or tensioned in an axially inner direction by the rim, whereas the shearband 105 forces and/or tensions the carcass ply 103 at least in radially upper portions or regions of its side portions in an axially outer direction. The tire 100 does not need inflation pressure in the tire cavity formed by the shearband 105, the carcass ply 103 and the rim 200 to support loads.

The present invention and/or its embodiments allow for instance to transform a pneumatic tire into a non-pneumatic tire by the provision, such as a post-cure provision, of a shearband as described herein. Provision of such a non-pneumatic tire is cost-efficient as existing tire building processes, materials, components, and/or machines may be used. An innerliner is not necessary and may be omitted in the building process. Also, manufacturing is relatively easy, particularly compared to some other techniques of manufacturing relatively complex non-pneumatic tires, e.g., requiring complex supporting structures. Also, filling the whole tire cavity with supporting material is not necessary which is beneficial for a reduced rolling resistance and/or results in limited costs. For instance, such tires could preferably be used for (but are not limited to such applications) medium load applications, including scooters, wheelchairs, quads, side by side vehicles, golfcarts, mowers, and industrial light and medium load vehicles. However, it is also possible to use the invention, or embodiments thereof, for other passenger vehicles. Another advantage consists in the possibility of using materials (such as those mentioned above) for the inboard shearband which help to reduce hysteresis and/or rolling resistance while providing desired stiffness for supporting load on the tire. Moreover, the present invention provides a relatively low-cost option that can turn existing pneumatic tires into top loaded airless tires. In particular, top loaded non-pneumatic tires can perform better than bottom loaded options. Finally, the shearband does not need to be applied in a tire factory but could be added in other places, such as at aftermarket facilities or retreading facilities.

Different aspects, embodiments, and features thereof, may be combined with one another.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A non-pneumatic tire comprising a tread portion; a pair of bead portions wherein each bead portion comprises a bead and a bead apex; a pair of sidewalls wherein each sidewall extends from the tread portion to a respective one of the bead portions; a belt portion comprising at least one belt layer at least partially supporting the tread portion; at least one carcass ply including a top portion extending radially below and along the belt layer, and two laterally opposite side portions wherein each side portion extends from the top portion towards a respective one of the bead portions; and a shearband extending in a circumferential direction radially below and along the top portion to support both side portions in an axial direction.

2. The non-pneumatic tire according to claim 1, wherein the shearband is attached to the carcass ply and extends in the circumferential direction along the top portion on a radially inner surface of the carcass ply and supports both side portions in an axial direction in contact with the carcass ply at a radially outer region of each side portion.

3. The non-pneumatic tire according to claim 1, wherein the tire is devoid of an innerliner comprising butyl rubber.

4. The non-pneumatic tire according to claim 1, wherein the bead comprises one or more of: multiple wires, a brass coating, and a rubber coating composition.

5. The non-pneumatic tire according to claim 1, wherein the shearband has a maximum radial thickness within a range of 70% to 300% of a maximum radial thickness of the tread portion, determined radially above the at least one belt layer.

6. The non-pneumatic tire according to claim 1, wherein the tire is a cured tire comprising a post-cure added shearband.

7. The non-pneumatic tire according to claim 1, wherein the shearband comprises one or more of:
i) multiple cord reinforced rubber composition layers arranged radially on top of one another;
ii) one or more of polyurethane and epoxy resin, having one or more of:
a density within a range of 0.5 g/cm³ to 2 g/cm³, determined according to ASTM D792, or equivalent,
a flexural modulus within a range of 0.5 GPa to 3 GPa, determined according to ASTM D790, or equivalent, and
a hardness within a range of 65 durometer A to 70 durometer D, determined according to ASTM D2240, or equivalent; and
iii) a thermoplastic polymer having one or more of:
a density within a range of 0.5 g/cm³ to 3 g/cm³, determined according to ASTM D792, or equivalent,
a flexural modulus within a range of 0.5 GPa to 10 GPa, according to ASTM D790, or equivalent, and
a hardness within a range of 65 durometer A to 70 durometer D, determined according to ASTM D2240, or equivalent.

8. The non-pneumatic tire according to claim 1, wherein the shearband comprises
at least four cord reinforced elastomer composition layers arranged radially on top of each other.

9. The non-pneumatic tire according to claim 1, wherein the shearband comprises at least one helically applied rubber ply strip comprising multiple parallel cords, wherein the cords have an angle with the circumferential direction of less than 5°.

10. The non-pneumatic tire according to claim 1, wherein the shearband comprises at least one of the following materials:
i) one or more of polyurethane and epoxy resin, having one or more of:
a density within a range of 0.5 g/cm³ to 2 g/cm³, determined according to ASTM D792, or equivalent,
a flexural modulus within a range of 0.5 GPa to 3 GPa, determined according to ASTM D790, or equivalent, and
a hardness within a range of 65 durometer A to 70 durometer D, determined according to ASTM D2240, or equivalent; and
ii) a thermoplastic polymer having one or more of:
a density within a range of 0.5 g/cm³ to 3 g/cm³, determined according to ASTM D792, or equivalent,
a flexural modulus within a range of 0.5 GPa to 10 GPa, according to ASTM D790, or equivalent, and
a hardness within a range of 65 durometer A to 70 durometer D, determined according to ASTM D2240, or equivalent.

11. The non-pneumatic tire according to claim 10, wherein the materials are one of
3D-printed;
reinforced by one or more of cords, filaments, fibers and fabrics.

12. The non-pneumatic tire according to claim 1, wherein the side portions of the carcass ply are resiliently tensioned by the shearband.

13. The non-pneumatic tire according to claim 1, wherein the tire comprises an innerliner comprising butyl rubber, on an inner surface of the at least one carcass ply, and wherein the shearband is attached to the innerliner and extends in the circumferential direction along the top portion on a radially inner surface of the innerliner and supports both side portions in an axial direction in contact with the innerliner, at a radially outer portion of each side portion.

14. A non-pneumatic tire comprising a tread portion; a pair of bead portions wherein each bead portion comprises a bead; a pair of sidewalls wherein each sidewall extends from the tread portion to a respective one of the bead portions; a belt portion comprising at least one belt layer at least partially supporting the tread portion; at least one carcass ply including a top portion extending radially below and along the belt layer, and two laterally opposite side portions wherein each side portion extends from the top portion towards a respective one of the bead portions; and a shearband extending in a circumferential direction radially below and along the top portion to support both side portions in an axial direction.

15. A tire rim assembly comprising a rim and the non-pneumatic tire according to claim 14, wherein the rim has a first circumferential flange portion radially supporting and forcing a first bead portion of the pair of bead portions in one of an axially inner direction and an axially outer direction; and a second circumferential flange portion radially supporting and forcing a second bead portion of the pair of bead portions in the same of the axially inner direction and the axially outer direction as the first bead portion.

16. The tire rim assembly according to claim 15, wherein at least one bead portion is at least partially axially clamped at at least one of the first circumferential flange portion and the second circumferential flange portion.

17. The tire rim assembly according to claim 15, wherein the flange portions tension both lateral side portions of the at least one carcass ply by forcing both bead portions into axially inner directions against a tension of the shearband forcing the side portions into axially outer directions.

18. The tire rim assembly according to claim 17, wherein an axial distance between axially innermost surfaces of the first bead portion and the second bead portion is at least 10% smaller than a maximum axial width of the shearband, when the tire is mounted to the rim.

19. The tire rim assembly according to claim 15, wherein the rim comprises multiple members comprising a circumferential hub member and a circumferential ring member, wherein the circumferential hub member comprises the first circumferential flange portion and wherein the circumferential ring member comprises the second flange portion, and wherein the circumferential ring member is axially mountable to the circumferential hub member.

20. The tire rim assembly according to claim 19, wherein the circumferential hub member comprises a further circumferential flange portion supporting the first bead portion against axial movement, and wherein the first bead portion is axially clamped between the first circumferential flange portion of the circumferential ring member and the further circumferential flange portion of the circumferential hub member.
